(19) United States
(12) Patent Application Publication
(10) Pub. No.: US 2026/0323802 A1
(43) Pub. Date: Oct. 15, 2026

(54) POOL CLEANERS WITH LIGHT SOURCE SYSTEMS AND METHODS

(71) Applicant: ZODIAC POOL CARE EUROPE, Belberaud (FR)

(72) Inventor: Simon Duffaut, Castelginest (FR)

(73) Assignee: ZODIAC POOL CARE EUROPE, Belberaud (FR)

(21) Appl. No.: 19/642,860

(22) Filed: Apr. 9, 2026

Related U.S. Application Data
(60) Provisional application No. 63/786,251, filed on Apr. 9, 2025.

(51) Int. Cl. H05B 47/11; E04H 4/16; H04N 23/56; H04N 23/74; H05B 47/125

(52) U.S. Cl. CPC H05B 47/11; E04H 4/1654; H04N 23/56; H04N 23/74; H05B 47/125

(57) ABSTRACT

A self-propelled pool cleaner for a swimming pool or spa generally includes a body and a camera supported on the body. The self-propelled pool cleaner additionally includes a light source supported on the body of the self-propelled pool cleaner. The light source is provided to illuminate a field of view of the camera. The self-propelled pool cleaner further includes a control system. The control system may control illumination from the light source based on ambient light within the swimming pool or spa.

### REFERENCE TO RELATED APPLICATION

This application claims the benefit of and priority to U.S. Provisional Patent Application No. 63/786,251, filed on Apr. 9, 2025, and entitled POOL CLEANERS WITH LIGHT SOURCE SYSTEMS AND METHODS, the content of which is hereby incorporated by reference in its entirety.

### FIELD OF THE INVENTION

The invention relates to swimming pool cleaners and other robots or cleaners, and more particularly, to systems and methods for cleaners with light sources.

### BACKGROUND

Numerous cleaning devices capable of autonomous or semi-autonomous movement within swimming pools and spas currently exist. The most common of these devices are pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Typically pools and other recreational water reservoirs are most commonly used during daylight. Having a pool cleaner active while the pool is being used can affect enjoyment of the pool and, in some circumstances, impact where users of the pool can swim. Thus, some pool cleaners are configured to operate outside of daylight hours (or when the pool is most commonly used) depending on a cleaning cycle. However, conventional pool cleaners may not be able to clean pools at night or in low light conditions due to lack of visibility and/or inability to identify hazards in the pool. Regardless of the duty cycle of the pool cleaner, traditional approaches to clean pools according to schedules may involve limiting a pool cleaner to a schedule with a limited time frame which may not give the pool cleaner adequate time to clean a desired region within the pool.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a self-propelled pool cleaner includes (i) at least one camera having a field of view of at least a portion of a surface of the swimming pool or spa and (ii) a light source controllable to illuminate the field of view of the camera.

According to some embodiments, a self-propelled pool cleaner includes a light source controllable to illuminate a surface in a path of the pool cleaner.

According to various embodiments, a self-propelled pool cleaner includes a light source controllable to illuminate a surface adjacent and/or proximate to the pool cleaner.

In some embodiments, a self-propelled pool cleaner includes a headlight controllable to illuminate a surface in a path of travel of the pool cleaner and/or adjacent and/or proximate to the pool cleaner.

According to certain embodiments, a self-propelled pool cleaner includes (i) at least one camera having a field of view of at least a portion of a surface of the swimming pool or spa and (ii) a light source controllable to display an image on the portion of the surface of the swimming pool or spa in the field of view of the camera.

According to some embodiments, a self-propelled pool cleaner includes a camera, a light source, and a control system. The light source may be configured to illuminate a field of view of the camera. The control system may control illumination from the light source based on ambient light within the swimming pool or spa.

In various embodiments, a self-propelled pool cleaner includes a camera, a light source, and a control system. The light source is configured to illuminate a field of view of the camera. The camera is movable in at least one direction, and the control system may control the light source based on movement of the camera.

In some embodiments, a self-propelled pool cleaner includes a body, a camera supported on the body, and a light source supported on the body. The body comprises a top end and a lower end, and the light source may be closer to the lower end of the body than to the top end.

According to certain embodiments, a method includes illuminating a portion of a surface of a swimming pool or spa within a field of view of a camera onboard a self-propelled pool cleaner using at least one light source onboard the pool cleaner.

According to various embodiments, a self-propelled pool cleaner for a swimming pool or spa includes a body, a camera supported on the body, and a light source supported on the body and configured to illuminate a field of view of the camera.

According to some embodiments, a self-propelled pool cleaner for a swimming pool or spa includes a body and a light source supported on the body, where the light source is orientable relative to the body.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures can be designated by matching reference characters for the sake of consistency and clarity.

FIG. 1 illustrates a pool system according to embodiments.

FIG. 2 is another view of the pool system of FIG. 1 according to embodiments.

FIG. 3 is another view of the pool system of FIG. 1 according to embodiments.

### DESCRIPTION OF THE INVENTION

Described herein are systems and methods for providing pool cleaners with one or more light sources.

In various embodiments, a pool cleaner may include a camera, and visual data from the camera may be utilized to perform various operations. As non-limiting examples, visual data from the camera may be utilized by the pool cleaner for navigation, localization, debris detection, performing a cleaning cycle and/or cleaning pattern, combinations thereof, and/or as otherwise desired. In some embodiments, the systems and methods described herein include one or more light sources to improve performance of the camera. In certain embodiments, the systems and methods described herein provide a solution to illuminate pool areas and/or debris within a pool area even when ambient light is relatively low and/or otherwise insufficient for operation of a submerged camera on the pool cleaner.

In various embodiments, the systems and methods described herein include one or more light sources (e.g., one or more headlights) integrated with the pool cleaner. The one or more light sources may be provided for illuminating pool areas adjacent and/or in proximity to the pool cleaner and/or to illuminate debris within the pool area. In certain embodiments, the one or more one or more light sources may improve performance of the one or more cameras by providing illumination underwater, thereby allowing the camera to capture visual data even if ambient light is low.

In some embodiments, the one or more light sources may be configured to generate various types of light, including light in the visible spectrum and/or light that is invisible to the human eye. As non-limiting examples, the one or more light sources may generate light in any color of the visible spectrum (e.g., red, green, blue, combinations thereof, etc.), a laser, UV, and/or IR. In embodiments with a plurality of light sources, a plurality of types of light may be generated. In some embodiments, a single light source may be controlled to provide various types of light. As a non-limiting example, a single light source may be turned on and provide light in any color of the visible spectrum as desired.

In certain embodiments, operation and/or activation of the one or more light sources may be controlled as desired.

As a non-limiting example, the one or more light sources may be activated (i.e., “on”) or deactivated (i.e., “off”), and/or may be controlled to have various intensities or brightnesses, for energy savings, to avoid disturbing a user, based on user input, based on sensor (or other) input, combinations thereof, and/or as otherwise desired. As a non-limiting example, the one or more light sources may be selectively deactivated responsive to a light sensor detecting that ambient light is at or above a threshold level and/or sufficient for operation of the camera and/or may be selectively activated responsive to the light sensor detecting that the ambient light is below the threshold level. As another non-limiting example, the one or more light sources may be selectively deactivated responsive to a detection of a user in the vicinity of the pool cleaner using the camera and/or may be selectively activated responsive to a detection that a user is not in the vicinity of the pool cleaner. As yet another non-limiting example, the one or more light sources may be selectively deactivated, responsive to a detection or determination that the pool cleaner is climbing a wall and/or may be selectively activated responsive to a detection or determination that the pool cleaner is navigating along a floor, a slope, a stair, and/or as otherwise desired. As another non-limiting example, the one or more light sources may be selectively deactivated based on a power level of one or more onboard batteries. As another non-limiting example, the one or more light sources may be controlled to have a maximum intensity or brightness based on ambient light being blow a threshold level (and/or as otherwise desired), and may be controlled to have a less than maximum intensity or brightness based on the ambient light being above a threshold level (and/or as otherwise desired. As a non-limiting example, the one or more light sources may be controlled to be at a 10% intensity or brightness, at a 20% intensity or brightness, at a 30% intensity or brightness, at a 40% intensity or brightness, at a 50% intensity or brightness, at a 60% intensity or brightness, at a 70% intensity or brightness, at an 80% intensity or brightness, at a 90% intensity or brightness, at a 100% intensity or brightness, combinations thereof, and/or as otherwise desired.

In other embodiments, the light sources may be controlled based on various combinations of input and/or information as desired, and/or as otherwise desired.

In some embodiments, the one or more light sources optionally may be controlled in conjunction with and/or relative to the camera. As one non-limiting example, the one or more light sources may be controlled to follow a change in orientation of the camera (e.g., such as but not limited to following rotation of a camera, following a pivoting of the camera, combinations thereof, and/or as otherwise desired. Additionally, or alternatively, the one or more light sources may be controlled relative to the camera to cancel a shadow in a field of view of the camera. In other embodiments, the light sources may be controlled based on combinations of information thereof and/or as otherwise desired.

In certain embodiments, the one or more light sources may be provided on various portions of the pool cleaner as desired. In a non-limiting example, the one or more light sources may be provided at a location on the body at or proximate to a lower end of the body (e.g., the portion of the body closest to a surface over which the pool cleaner is navigating). In certain embodiments, the one or more light sources may be provided on the body at a location that is closer to the lower end of the body than to a top end of the body. Optionally, providing the light sources at or proximate to the lower end of the body (or closer to the lower end than to the top end) may improve illumination for debris detection. As a non-limiting example, such light sources provided at or proximate to the lower end may highlight debris and/or increase a shadow generated by the debris when illuminated by the light sources. In other embodiments, the light sources may be provided at other locations on or relative to the body of the pool cleaner and/or the camera as desired.

Optionally, the one or more light sources may be utilized to display one or more images, videos, and/or other visual information on a surface of the pool. Optionally, the image or other visual information displayed on the surface of the pool may be utilized by the pool cleaner to measure a distance from the surface.

In certain embodiments, a pool cleaner for a swimming pool or spa includes a light source submergible with the pool cleaner underwater. In some embodiments, a pool cleaner for a swimming pool or spa may include a pool cleaner and a float connected to the pool cleaner including a light source. In some embodiments, a pool cleaner may be configured to (i) travel along a submerged surface of a pool or spa and/or (ii) perform a cleaning operation on the submerged surface, wherein the pool cleaner comprises a light source. In some embodiments, a pool cleaner may include a body and a light source attachable to and removable from the body. In certain embodiments, a device may include pool equipment for a swimming pool or spa, wherein the pool equipment comprises a surface at least partially submergible within a pool or spa, and wherein the pool equipment comprises a light source on the surface.

In some embodiments, a pool cleaner system may include a pool cleaner comprising an onboard battery, at least one light source, and a connection system electrically connecting the light source with the onboard battery of the pool cleaner. In certain embodiments, a pool cleaner system may include a pool cleaner with an onboard battery, a light source, and a connection system enabling selective electrical connection between the pool cleaner and the light source. In some embodiments, a pool cleaner may include a light source configured to operate in a wavelength range between ten nm and one mm. In some embodiments, a pool cleaner may include a light source configured to illuminate a field of view (FOV) of a camera.

In some embodiments, a method may include controlling a light source to illuminate a region around a pool cleaner, controlling a camera to capture surface data in the region, and controlling a motor to rotate the light source relative to the camera. In some embodiments, a method may include controlling a light source to illuminate a region near a pool surface, controlling a camera to capture surface data in the region, and controlling a motor to rotate the light source relative to the camera. In some embodiments, a method may include controlling a light source on a float to illuminate a region in a pool and controlling a pool cleaner connected to the float to clean a surface in the region illuminated by the light source. In some embodiments, a method may include controlling one or more light sources to project an image onto a surface in a pool.

Also disclosed is a non-transitory computer readable storage medium comprising a plurality of instructions executable by one or more processors, the plurality of instructions comprising instructions which, when executed by the one or more processors, cause the one or more processors to perform actions including the method of any preceding or subsequent statement or combination of statements.

In some embodiments, the pool cleaner comprises a body with a top and sidewalls, and the light source is on the top and/or on the sidewalls of the body and/or the light source includes two or more light sources. In addition, or alternatively, the light source is configured to emit collimated light. In some embodiments, the pool surface is submerged, and the image is used to measure a distance from the pool surface. In some embodiments, the float is connected to the pool cleaner and is configured to float at or near a water surface above the pool cleaner. In some embodiments, the light source is positioned on a removable component of the pool cleaner. In some embodiments, the light source is configured to be selectively powered.

In some embodiments, the light source is automatically adjustable between a stowed configuration and a deployed configuration. In some embodiments, when in the stowed configuration, the light source is within a body or a chassis of the pool cleaner. In some embodiments, the light source is configured to be selectively enabled or disabled based at least in part on an input. In addition, or alternatively, the light source may extend around at least a portion of a perimeter of the pool cleaner.

Various other benefits and advantages may be realized with the systems, devices, and methods provided herein, and the aforementioned advantages should not be considered limiting.

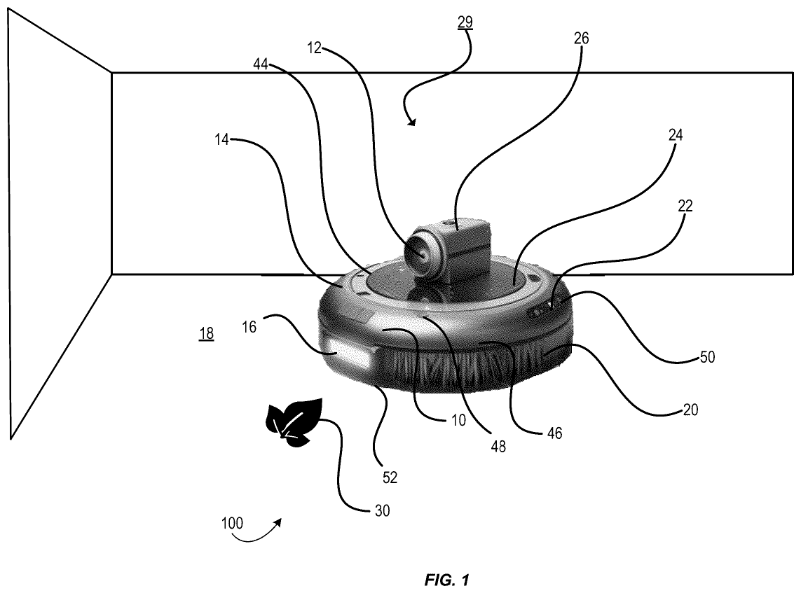

FIGS. 1-3 illustrate a pool system 11 with a pool 29 and one or more pieces of pool equipment 13 according to embodiments. The pool 29 may have various shapes, sizes, and dimensions, as desired, and those illustrated in FIGS. 1-3 should not be considered limiting.

The pool equipment 13 may be various types of pool equipment capable of autonomous or semi-autonomous movement within the pool 29. The number of pool equipment 13 provided with the pool system 11 should not be considered limiting, and embodiments with a plurality of pieces of pool equipment 13 may include similar or dissimilar equipment as desired. In certain embodiments, the pool equipment 13 may be equipment configured to travel along one or more submerged surfaces 18 of the pool 29 and/or configured to perform a cleaning operation on one or more submerged surfaces 18 of the pool 29 and/or configured to navigate autonomously and/or semi-autonomously within the pool 10.

In one non-limiting example, the pool equipment 13 may be various types of pool cleaners 10 as desired and is not limited to the examples disclosed herein. In certain embodiments, and as illustrated in FIGS. 1-3, the pool equipment 13 is a pool cleaner 10.

As illustrated in FIGS. 1-3, the pool cleaner 10 generally includes a body 14 which is movable relative to (e.g., along) one or more submerged surfaces 18 of the pool 29. In certain embodiments, the body 14 may be formed by a chassis and a housing, although it need not in other embodiments. While the body 14 may have various shapes, sizes, or configurations as desired, in some embodiments, the body 14 includes a nominal top end 44, a nominal lower end 52, and one or more sidewalls 46. The pool cleaner 10 may include optional motive elements (not depicted), which may be various suitable devices or structures suitable for enabling movement of the pool cleaner 10 along a surface. Non-limiting examples of motive elements include, but are not limited to, wheels, rollers, feet, tracks, propellers, propulsion systems, combinations thereof, and/or other suitable motive elements as desired.

The pool cleaner 10 may include various components on and/or within the body 14 such as a motor block, a filter, a pump, a controller, combinations thereof, and/or other features as desired. The pool cleaner 10 optionally may include one or more cleaning elements 20 (e.g., a brush assembly with one or more brushes) suitable for cleaning a surface and/or directing debris into the pool cleaner 10 and/or towards a filter of the pool cleaner 10. Optionally, and as illustrated in FIG. 1, the motive elements may be shrouded by the one or more cleaning elements 20. In other embodiments, the motive elements need not be shrouded by the cleaning elements 20. As a non-limiting example, in other embodiments, the pool cleaner 10 may include motive elements (e.g., tracks and/or wheels) on opposing lateral sides of the body 14 of the pool cleaner 10, and a cleaning element 20 may be provided at a nominal front end and/or rear end of the body 14. The cleaning elements 20 may include, without limitation, bristles, brushes, aprons (e.g., continuous uniform surface), combinations thereof, and/or other devices suitable or mechanisms suitable for cleaning a surface and/or directing debris into the pool cleaner 10 and/or towards a filter of the pool cleaner 10. Optionally, and as illustrated in FIG. 1, the cleaning elements 20 may at least partially surround the pool cleaner 10, although they need not in other embodiments. The cleaning elements 20 may be made of any suitable material, such as, without limitation, polymers, fabric, metals, alloys, and/or combinations thereof.

In various embodiments, the pool cleaner 10 includes one or more communication modules allowing for wireless communication (e.g., Bluetooth, Li-Fi, LoRa, radio frequency, cellular, NFC, Wi-Fi, etc.) with external or remote devices such as external control devices, the internet, cloud services, smartphones, other user devices, etc.

In some embodiments, the pool cleaner 10 may include one or more onboard batteries for storing energy. The onboard batteries may be provided at various locations on or within the pool cleaner 10 as desired. As non-limiting examples, the onboard batteries may be provided within the body 14 and/or may at least partially form an outer surface of the pool cleaner 10. The batteries may be charged at a docking station (not depicted), a line power source, and/or may be charged using a power generating source (e.g., solar panels). Alternatively, or additionally, the pool cleaner 10 may have a power cord that powers the pool cleaner 10 from an external source.

In certain embodiments, the pool cleaner 10 may include a control system 50 (or controller) with one or more processing units and/or one or more memory devices on and/or associated with the pool cleaner 10. The processing unit may be various suitable processing devices or combinations of devices including but not limited to one or more application specific integrated circuits, digital signal processors, digital signal processing devices, programmable logic devices, field programmable gate arrays, processors, controllers, micro-controllers, microprocessors, other electronic units, and/or a combination thereof. The one or more memory devices may be any machine-readable medium that can be accessed by the processor, including but not limited to any type of long term, short term, volatile, nonvolatile, or other storage medium, and is not to be limited to any particular type of memory or number of memories, or type of media upon which memory is stored. Moreover, as disclosed herein, the term “storage medium,” “storage” or “memory” can represent one or more memories for storing data, including read only memory (ROM), random access memory (RAM), magnetic RAM, core memory, magnetic disk storage mediums, optical storage mediums, flash memory devices and/or other machine-readable mediums for storing information. The term “machine-readable medium” includes, but is not limited to, portable or fixed storage devices, optical storage devices, wireless channels, and/or various other storage mediums capable of storing that contain or carry instruction(s) and/or data.

As mentioned, the pool cleaner 10 illustrated should not be considered limiting as the pool cleaner 10 described herein may have fewer, additional, or various other combinations of features as desired. Other non-limiting examples of pool cleaners 10 may include those described in U.S. Pat. Nos. 10,316,534, 9,488,154, 8,578,538, and U.S. Patent Publication No. 2014/0303810, all of which are hereby incorporated by reference in their entireties.

As illustrated in FIGS. 1-3, the pool cleaner 10 (or pool equipment 13 generally) may include one or more cameras 26 for capturing a field of view (FOV) in proximity to the pool cleaner 10. The one or more cameras 26 may include one or more optical assemblies 12 including, without limitation, charged coupled devices (CCD), lenses, light sources, and/or focusing optics. The one or more cameras 26 may be used to facilitate navigation of the pool cleaner 10 along the submerged surfaces 18 by capturing one or more images and/or continuous video of surroundings.

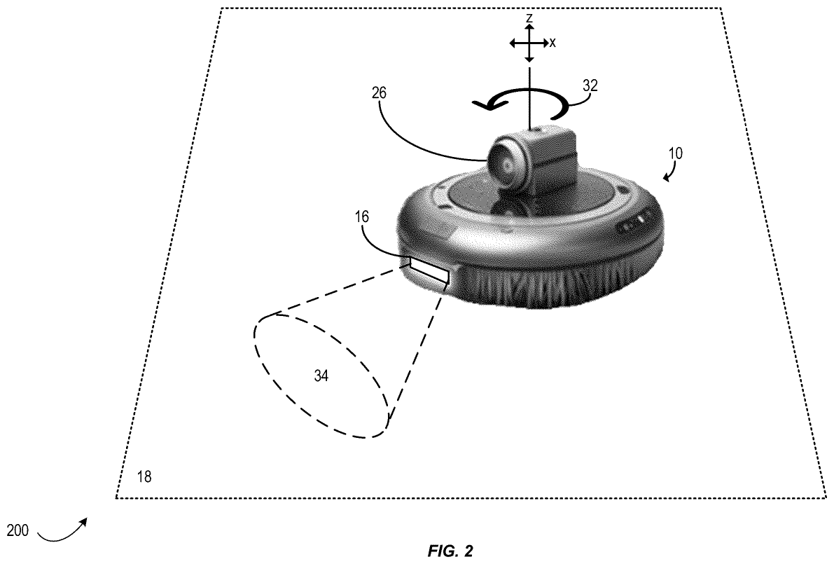

In certain embodiments, the pool cleaner 10 (or pool equipment 13 generally) also includes one or more light sources 16 (or one or more headlights) configured to illuminate a region of interest (ROI) 34 of the submerged surfaces 18 (see, e.g., FIG. 2) and/or other location relative to the body 14 of the pool cleaner 10. In some embodiments, a single light source 16 may be included, while in other embodiments, a plurality of light sources 16 may be included. In a non-limiting example, the one or more light sources 16 may be one or more headlights.

The one or more light sources 16 may be various types of light sources suitable for illuminating the ROI 34 and/or to improve performance of the one or more cameras 26. As non-limiting examples, the one or more light sources 16 may be, without limitation, visible spectrum light sources, infrared (IR) spectrum light sources, and/or ultraviolet (UV) spectrum light sources, combinations thereof, and/or as otherwise desired. By way of a non-limiting example, the one or more light sources 16 may operate in a wavelength range between ten nanometers (nm) and one millimeter (mm).

The one or more light sources 16 may illuminate the ROI 34 to enable the one or more cameras 26 to capture surface data. The surface data may include, without limitation, information related to the submerged surface 18, debris 30 (e.g., dirt, leaves, objects) on the submerged surface 18, contours of the submerged surface 18, combinations thereof, and/or other information in the FOV and/or ROI as desired. In some examples, the one or more light sources 16 optionally may be collimated light (e.g., laser). In addition, or alternatively, the one or more light sources 16 optionally may emit an image (e.g., fiducial marker) onto the submerged surface 18. As a non-limiting example, the emitted image may enable the pool cleaner 10 to determine a distance to an object or surface, a contour or structure of an object or surface, a navigation path of the pool cleaner, and/or combinations thereof and/or as otherwise desired.

In certain embodiments, the one or more light sources 16 may be selectively enabled (e.g., turned ON) or disabled (e.g., turned OFF) automatically based at least in part on one or more parameters (e.g., duty cycle, schedule, detected light conditions, battery condition (to save energy), user activity (to avoid disturbing a detected user), etc.) or by user preference. As a non-limiting example, the one or more light sources 16 may be selectively deactivated responsive to a light sensor detecting that ambient light is at or above a threshold level and/or sufficient for operation of the camera and/or may be selectively activated responsive to the light sensor detecting that the ambient light is below the threshold level. As another non-limiting example, the one or more light sources 16 may be selectively deactivated responsive to a detection of a user in the vicinity of the pool cleaner using the camera and/or may be selectively activated responsive to a detection that a user is not in the vicinity of the pool cleaner. As yet another non-limiting example, the one or more light sources 16 may be selectively deactivated responsive to a detection or determination that the pool cleaner is climbing a wall and/or may be selectively activated responsive to a detection or determination that the pool cleaner is navigating along a floor, a slope, a stair, and/or as otherwise desired. As another non-limiting example, the one or more light sources 16 may be selectively deactivated based on a power level of one or more onboard batteries. In other embodiments, the one or more light sources 16 may be controlled based on various combinations of input and/or information as desired, and/or as otherwise desired.

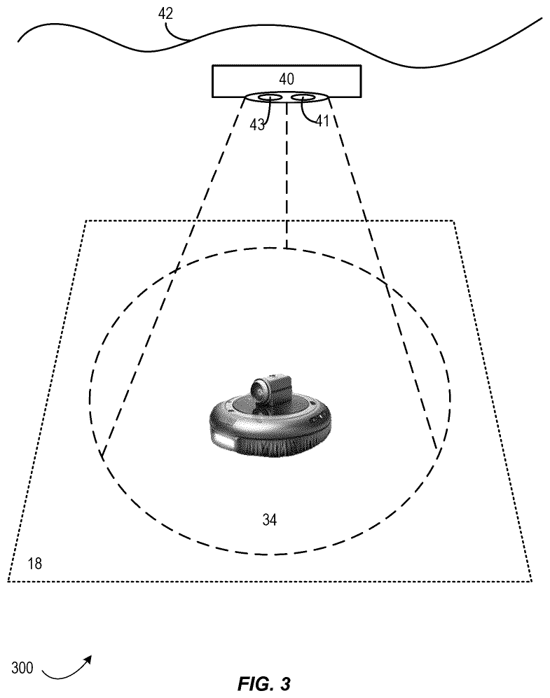

The one or more cameras 26 and/or one or more light sources 16 may be embedded/attached with the pool cleaner 10 and/or may be detachable from the pool cleaner 10 as desired. The one or more cameras 26 and/or one or more light sources 16 may be provided at various locations on, within, and/or relative to the pool cleaner 10 as desired. In some embodiments, one or more cameras 26 and/or one or more light sources 16 may be provided on an outer surface of the body 14 and thereby at least partially form an outer surface of the pool cleaner 10. As a non-limiting example, in FIG. 1, the one or more cameras 26 and/or one or more light sources 16 are provided on a surface 24 of the body 14 and a side surface of the body 14, respectively. However, in other embodiments, the one or more cameras 26 and/or one or more light sources 16 may be provided at other locations as desired, such as on one or more sidewalls. In certain embodiments, the one or more cameras 26 and/or one or more light sources 16 (and/or components thereof) may be arranged in a pattern or arrangement on the body 14 to optimize illumination for the image and/or video capture in regions of interest (ROI) at least partially surrounding the pool cleaner 10. Moreover, and with reference to FIG. 3, while the one or more cameras 26 and/or one or more light sources 16 may be associated with the body 14 of the pool cleaner 10, one or more light sources 16 additionally or alternatively may be connected to a float configured to float in a region above or around the pool cleaner 10 with a FOV surrounding the pool cleaner. In some examples, the float may be at least partially buoyant.

In some embodiments, the one or more cameras 26 and/or one or more light sources 16 may have a fixed orientation relative to the body 14. In other embodiments, the one or more cameras 26 and/or one or more light sources 16 may be adjustable and/or movable in at least one direction (e.g., via pivoting, rotating, linear movement, combinations thereof, etc.). In a non-limiting example, and with reference to FIG. 2, the one or more cameras 26 and/or one or more light sources 16 may be configured to rotate in one or more directions 32 about a suitable axis (e.g., pitch, roll, yaw). In some embodiments, the one or more cameras 26 may provide a panoramic view surrounding the pool cleaner 10 providing up to three hundred and sixty degrees of view along at least one suitable axis. Similarly, the one or more light sources 16 may be configured to illuminate a ROI 34 at least partially surrounding the pool cleaner 10 providing up to three hundred and sixty degrees of view along at least one suitable axis.

Optionally, the one or more light sources 16, when adjustable, may be controlled in conjunction with and/or relative to the camera 26. As non-limiting examples, the one or more light sources 16 may be controlled to follow a change in orientation or movement of the camera 26 and/or may be controlled to cancel shadows or illuminate areas with lower light. In other embodiments, the one or more light sources 16 need not follow the camera 26.

Additionally, or alternatively, the one or more cameras 26 and/or one or more light sources 16 (and/or components thereof) may have various geometries or shapes as desired, optionally to optimize operation of the one or more cameras 26 and/or one or more light sources 16. In other embodiments, the one or more cameras 26 and/or one or more light sources 16 may be positioned or positionable in the body 14 (e.g., within the chassis or the housing) when not in use, and the one or more cameras 26 and/or one or more light sources 16 may be selectively deployed for use using various deployment systems or mechanisms as desired. As non-limiting examples, a retractable mechanism, slides, rollers, combinations thereof, and/or other devices or mechanisms as desired may be utilized to selectively stow or deploy the one or more cameras 26 and/or one or more light sources 16 as desired.

In various embodiments, and regardless of whether the one or more cameras 26 and/or one or more light sources 16 are embedded with the pool cleaner 10 or detachable from the pool cleaner 10, the one or more cameras 26 and/or one or more light sources 16 optionally may be adjustable or movable relative to the body 14.

In some embodiments, the movement or adjustment of the one or more cameras 26 and/or one or more light sources 16 optionally includes movement or adjustment between stowed and deployed configurations. In some embodiments, and as previously discussed, in the stowed configuration, the one or more cameras 26 and/or one or more light sources 16 optionally may be housed partially or wholly within the body 14. However, in other embodiments, the one or more cameras 26 and/or one or more light sources 16 need not be within the body 14 in the stowed configuration. As a non-limiting example, the one or more cameras 26 and/or one or more light sources 16 may be provided on the surface 24 of the pool cleaner 10. In this embodiment, in a stowed configuration, at least some of the cameras 26 may be stored or otherwise not deployed, and in a deployed configuration, the one or more cameras 26 and/or one or more light sources 16 may be selectively deployed based at least in part on instructions from the pool cleaner 10, power parameters, and/or one or more thresholds (e.g., pool cleaner 10 needs more information on position or debris 30). Other deployment and stowage systems and/or mechanisms may be utilized as desired.

In embodiments where the one or more cameras 26 and/or one or more light sources 16 are movable between stowed and deployed configurations (and/or are otherwise movable and/or adjustable relative to the body 14), such movement may be controlled (e.g., by an onboard control system) automatically, responsive to a trigger event (e.g., an end of a cleaning cycle, a detected battery status, a scheduled time, an operational status, a navigational position within the pool, a detected state of the pool (e.g., high turbidity), etc.), responsive to a command from a user as desired, combinations thereof, and/or as otherwise desired.

Additionally, or alternatively, the one or more cameras 26 and/or one or more light sources 16 may be movable or adjustable to control positioning and/or orientation of the one or more cameras 26 and/or one or more light sources 16 relative to the pool cleaner 10 and/or the submerged surface 18 (e.g., by way of a mechanism on the surface 24). In these embodiments, the one or more cameras 26 and/or one or more light sources 16 may be adjustable or movable via various mechanisms or techniques as desired, such as but not limited to tilting, angling, pivoting, rotating, bending, repositioning (e.g., to another location on the body 14), combinations thereof, and/or as otherwise desired. In some embodiments, the one or more cameras 26 and/or one or more light sources 16 are automatically adjustable relative to the pool cleaner 10 and/or the submerged surface 18, while in other embodiments, the one or more cameras 26 and/or one or more light sources 16 may be adjusted or moved by the user.

In some embodiments, the pool cleaner 10 and/or the one or more cameras 26 may include one or more onboard sensors 48 configured to detect information utilized to control the one or more cameras 26 and/or the one or more light sources 16. As non-limiting examples, the one or more sensors 48 may include a sensor configured to detect or determine a position or orientation of the sun (e.g., a sun tracker sensor) and/or to detect light rays, such as but not limited to an intensity of light (e.g., ambient light), incidence of light rays, combinations thereof, and/or as otherwise desired. In embodiments with such sensors, the sensors may be provided at various locations on the pool cleaner 10 as desired. Optionally, based on the information sensed by the one or more sensors, the position and/or orientation of the one or more cameras 26 and/or one or more light sources 16 may be automatically controlled (e.g., by the onboard control system). As a non-limiting example, the one or more cameras 26 and/or one or more light sources 16 may be automatically tilted, angled, or bent to adapt to an angle of incidence of light rays and/or a change in position of the sun. For example, the one or more light sources 16 may be stowed and/or off when ambient lighting conditions (not from the one or more light sources 16) are determined to be optimal for operation of the one or more cameras 26.

In certain embodiments, the one or more cameras 26 and/or one or more light sources 16 may be coupled with the one or more onboard batteries of the pool cleaner 10 (and/or directly to other components as desired) using various connection or coupling systems such as desired. As non-limiting examples, the one or more cameras 26 and/or one or more light sources 16 may be connected with one or more onboard batteries (and/or other components) using induction connections, wired connections, combinations thereof, and/or as otherwise desired. In some embodiments, the connections between the one or more cameras 26 and/or one or more light sources 16 and the components of the pool cleaner 10 are fixed. In other embodiments, the connections are suitable devices or mechanisms such that the one or more one or more cameras 26 and/or one or more light sources 16 are detachable from and/or may be electrically disconnected as desired.

Optionally, the one or more cameras 26 and/or one or more light sources 16 include various features facilitating communication and/or interaction with a user and/or a user device. As a non-limiting example, in some embodiments, the one or more cameras 26 and/or one or more light sources 16 may include a human machine interface (HMI) 22 with one or more features for providing information to a user and/or for receiving input from a user. The HMI 22 includes various features for receiving input from and/or providing output to a user, such as but not limited to a display, a speaker, a button, a switch, a dial, a keypad, a light source, combinations thereof, and/or as otherwise desired. The information provided to the user via the HMI 22 may be various information as desired. As another non-limiting example, in some embodiments, the one or more cameras 26 and/or one or more light sources 16 may include a communication module facilitating wireless communication.

As non-limiting examples, and referring to FIG. 2, the cameras 26 and/or the one or more light sources 16 may be operable while the pool cleaner 10 is submerged, such as on the submerged surface 18 of the pool 29. In other embodiments, the one or more cameras 26 and/or one or more light sources 16 are operable while the pool cleaner 10 is outside of the pool. Additionally, or alternatively, the one or more cameras 26 and/or one or more light sources 16 may be operable while the pool cleaner 10 is partially submerged, such as but not limited to when the pool cleaner 10 is at a waterline 42 of the pool. Optionally, at the waterline 42, the pool cleaner 10 may be coupled to a floatation system 40 to facilitate positioning of the pool cleaner 10 at the waterline 42. In other embodiments, the floatation system 40 may be omitted. In various embodiments, at the waterline 42, the one or more cameras 26 and/or one or more light sources 16 on the pool cleaner 10 may be above the waterline 42, below the waterline 42, or both.

Referring to FIG. 3, in some embodiments, as mentioned previously the pool cleaner 10 optionally includes a floatation system 40 with the one or more cameras 43 and/or one or more light sources 41. In this embodiment, the pool cleaner 10 need not include the onboard one or more cameras 26 and/or one or more light sources 16, although in certain embodiments the pool cleaner 10 may also have one or more cameras 26 and/or one or more light sources 16 as discussed previously.

In certain embodiments, the floatation system 40 with the one or more cameras 43 and/or one or more light sources 41 may be electrically connected to the pool cleaner 10 via a connection system (not depicted). In certain embodiments, the connection system electrically connects the one or more cameras 43 and/or one or more light sources 41 on the floatation system 40 with the battery onboard the pool cleaner 10, thereby allowing for the transfer of energy from the floating one or more cameras 43 and/or one or more light sources 41 to the battery of the pool cleaner 10. In certain embodiments, the connection system is a detachable system such that the battery of the pool cleaner 10 may be selectively connected to or disconnected from the floating one or more cameras 43 and/or one or more light sources 41 as desired. Optionally, the connection system may include cabling with at least one connector engageable with the pool cleaner 10 such that the pool cleaner 10 may be connected to or disconnected from the floatation system 40 with the one or more one or more cameras 43 and/or one or more light sources 41 as desired. Various types of connectors may be utilized as desired, including induction connectors, wired connectors, mechanical connectors, combinations thereof, and/or as otherwise desired.

Optionally, the floatation system 40 with the onboard one or more cameras 43 and/or one or more light sources 41 includes an onboard battery. In these embodiments, when the pool cleaner 10 is disconnected from the floatation system 40 (and/or as otherwise desired), the one or more floatation system 40 batteries may store energy for the one or more cameras 43 and/or one or more light sources 41.

Optionally, the floatation system 40 with the one or more cameras 43 and/or one or more light sources 41 additionally includes one or more sensors for detecting or sensing information about the pool cleaner 10 and/or environment surrounding the pool cleaner 10. The sensors may be various sensors as desired, such as but not limited to optical sensors, cameras, water presence sensors, water temperature sensors, water chemistry sensors, flow sensors, acoustic sensors, combinations thereof, and/or as otherwise desired. In one non-limiting example, the one or more sensors includes the one or more cameras 43. In certain embodiments, the data obtained by the one or more sensors may be communicated to the pool cleaner 10 and/or to a remote user device. In some embodiments, the data from the one or more sensors may be utilized by the pool cleaner 10 to perform one or more cleaning and/or navigation operations. As a non-limiting example, the one or more cameras 43 and/or one or more light sources 41 as the one or more sensors on the float may detect debris 30 (e.g., leaves) within the pool 29 and a location of the debris 30 in the pool 29, and the pool cleaner 10 may be controlled to navigate to the location of the debris based on the data from the camera. Other controls utilizing the sensor data may be utilized as desired. The sensors may alternatively or additionally be on or within the pool cleaner 10.

In certain embodiments, in addition to performing cleaning operations and other traditional pool cleaner operations, the pool cleaner 10 may perform various processes or operations when it includes the one or more cameras 26 and/or one or more light sources 16. In some embodiments, the one or more cameras 43 and/or one or more light sources 41 can be configured the same as one or more cameras 26 and/or one or more light sources 16 as discussed previously. In various examples, the one or more cameras 26 and/or one or more light sources 16 are the same as the one or more cameras 43 and/or one or more light sources 41. Examples are described in greater detail below, but these processes should not be considered limiting, and in other embodiments, additional and/or alternative operations may be performed as desired.

In some embodiments, the pool cleaner 10 may utilize the one or more cameras 26 and/or one or more light sources 16 as a light detector to determine a time of day. As a non-limiting example, based on a characteristic of the light received by the cameras 26 (e.g., intensity, direction, luminosity, amount, etc.), the pool cleaner 10 may estimate or determine a time of day at the location of the pool cleaner 10.

Additionally, or alternatively, the pool cleaner 10 may perform various operations to optimize the use of the one or more cameras 26 and/or one or more light sources 16. As a non-limiting example, a characteristic of light may be detected (e.g., by an onboard sensor), and based on the characteristic, the pool cleaner 10 may reposition itself and/or the one or more cameras 26 and/or one or more light sources 16. As a non-limiting example, the pool cleaner 10 may detect light intensity, and the pool cleaner 10 may position and/or may orient itself and/or the one or more cameras 26 to face a direction of highest intensity, until the detected light intensity reaches a threshold, and/or until a location of the detected light intensity is determined to be a maximum within the pool. As another non-limiting example, the direction of the light may be tracked, and the pool cleaner 10 may position and/or orient itself and/or the cone or more cameras 26 and/or one or more light sources 16 to face towards and/or away from the direction of the light.

As another non-limiting example, the pool cleaner 10 may identify a center of the pool 29 (using various localization and/or position sensing techniques) and may control itself to be positioned at the center of the pool 29 for charging. Additionally, or alternatively, the pool cleaner 10 may identify optimal locations within the pool 29 for charging using the one or more cameras 26 by monitoring or detecting light intensity, projected fiducial markers (e.g., projecting images on the submerged surface 18), shadows, sun positioning, combinations thereof, and/or as otherwise desired. In some embodiments, the pool cleaner 10 may position itself at the center of the pool 29 and/or the location determined to be optimal for charging automatically (e.g., at an end of a cycle, based on a battery level, combinations thereof, etc.) and/or as directed by a user using one or more solar panels (not depicted).

Various other processes or controls may be implemented as desired, and the aforementioned examples should not be considered limiting. Moreover, various other benefits and advantages may be realized with the systems, devices, and methods provided herein, and the aforementioned advantages should not be considered limiting.

Exemplary concepts or combinations of features of the invention may include:
A. A self-propelled pool cleaner for a swimming pool or spa, the pool cleaner comprising (i) at least one camera having a field of view of at least a portion of a surface of the swimming pool or spa and (ii) a light source controllable to illuminate the field of view of the camera.
B. The pool cleaner, system, method, or storage medium of any preceding or subsequent statement or combination of statements, wherein the pool cleaner is configured to control at least one characteristic of the light source.
C. The pool cleaner, system, method, or storage medium of any preceding or subsequent statement or combination of statements, wherein the at least one characteristic of the light source is one or more of:
   i. a status (ON/OFF) of the light source;
   ii. a color of visible light emitted by the light source;
   iii. a wavelength of light emitted by the light source; and/or
   iv. an intensity of light emitted by the light source.
D. The pool cleaner, system, method, or storage medium of any preceding or subsequent statement or combination of statements, wherein the pool cleaner is configured to control the at least one characteristic of the light source based on at least one characteristic of the camera.
E. The pool cleaner, system, method, or storage medium of any preceding or subsequent statement or combination of statements, wherein the at least one characteristic of the camera is a change in angle or orientation of the camera relative to the pool cleaner.
F. The pool cleaner, system, method, or storage medium of any preceding or subsequent statement or combination of statements, further comprising at least one sensor, and wherein the pool cleaner is configured to control at least one characteristic of the light source based on sensed information from the at least one sensor.
G. The pool cleaner, system, method, or storage medium of any preceding or subsequent statement or combination of statements, wherein the sensor is a depth or pressure sensor, and wherein the pool cleaner is configured to control the at least one characteristic of the light source based on a detected depth or pressure.
H. The pool cleaner, system, method, or storage medium of any preceding or subsequent statement or combination of statements, wherein the sensor is an ambient light sensor, and wherein the pool cleaner is configured to control the at least one characteristic of the light source based on the detected ambient light.
I. The pool cleaner, system, method, or storage medium of any preceding or subsequent statement or combination of statements, wherein the sensor is a proximity sensor, and wherein the pool cleaner is configured to control the at least one characteristic of the light source based on a detected proximity or distance to an object.
J. A self-propelled pool cleaner for a swimming pool or spa, the pool cleaner comprising a light source controllable to illuminate a surface in a path of the pool cleaner.
K. A self-propelled pool cleaner for a swimming pool or spa, the pool cleaner comprising a light source controllable to illuminate a surface adjacent and/or proximate to the pool cleaner.
L. A self-propelled pool cleaner for a swimming pool or spa, the pool cleaner comprising a headlight controllable to illuminate a surface in a path of travel of the pool cleaner and/or adjacent and/or proximate to the pool cleaner.
M. A self-propelled pool cleaner for a swimming pool or spa, the pool cleaner comprising (i) at least one camera having a field of view of at least a portion of a surface of the swimming pool or spa and (ii) a light source controllable to display an image on the portion of the surface of the swimming pool or spa in the field of view of the camera.
N. A self-propelled pool cleaner for a swimming pool or spa, the pool cleaner comprising a camera, a light source, and a control system, wherein the light source is configured to illuminate a field of view of the camera, and wherein the control system is configured to control illumination from the light source based on ambient light within the swimming pool or spa.
O. A self-propelled pool cleaner for a swimming pool or spa, the pool cleaner comprising a camera, a light source, and a control system, wherein the light source is configured to illuminate a field of view of the camera, wherein the camera is movable in at least one direction, and wherein the control system is configured to control the light source based on movement of the camera.
P. A self-propelled pool cleaner for a swimming pool or spa, the pool cleaner comprising a body, a camera supported on the body, and a light source supported on the body, wherein the body comprises a top end and a lower end, and wherein the light source is closer to the lower end of the body than to the top end.
Q. The pool cleaner, system, method, or storage medium of any preceding or subsequent statement or combination of statements, wherein the light source is at or proximate to the lower end of the body.
R. The pool cleaner, system, method, or storage medium of any preceding or subsequent statement or combination of statements, wherein the light source is a headlight.
S. The pool cleaner, system, method, or storage medium of any preceding or subsequent statement or combination of statements, wherein the light source is a first light source of a plurality of light sources.
T. The pool cleaner, system, method, or storage medium of any preceding or subsequent statement or combination of statements, wherein the plurality of light sources are a plurality of headlights.
U. The pool cleaner, system, method, or storage medium of any preceding or subsequent statement or combination of statements, wherein the camera is more proximate to a top end of the body than to the lower end.
V. The pool cleaner, system, method, or storage medium of any preceding or subsequent statement or combination of statements, wherein the camera is at the top end of the body.
W. The pool cleaner, system, method, or storage medium of any preceding or subsequent statement or combination of statements, wherein the control system is configured to control the light source based on movement of the camera by controlling the light source to follow a change in orientation or movement of the camera and/or to cancel shadows and/or illuminate areas with lower light.
X. A method comprising illuminating a portion of a surface of a swimming pool or spa within a field of view of a camera onboard a self-propelled pool cleaner using at least one light source onboard the pool cleaner.
Y. The pool cleaner, system, method, or storage medium of any preceding or subsequent statement or combination of statements, further comprising controlling at least one characteristic of the light source based on at least one of (i) at least one characteristic of the camera and/or (ii) information obtained from an onboard sensor.
Z. The pool cleaner, system, method, or storage medium of any preceding or subsequent statement or combination of statements, wherein illuminating the portion of the surface within the field of view comprises displaying one or more images on the portion of the surface.
AA. The pool cleaner, system, method, or storage medium of any preceding or subsequent statement or combination of statements, further comprising obtaining image data of the field of view using the camera.
BB. The pool cleaner, system, method, or storage medium of any preceding or subsequent statement or combination of statements, further comprising generating a control response based on the obtained image data.
CC. The pool cleaner, system, method, or storage medium of any preceding or subsequent statement or combination of statements, wherein generating the control response comprises identifying debris within the field of view and causing the pool cleaner to navigate toward the debris.
DD. The pool cleaner, system, method, or storage medium of any preceding or subsequent statement or combination of statements, wherein the light source and/or headlight is angled downwards.
EE. The pool cleaner, system, method, or storage medium of any preceding or subsequent statement or combination of statements, wherein the surface is a surface on which the pool cleaner is positioned and/or travelling.
FF. A non-transitory computer readable storage medium comprising a plurality of instructions executable by one or more processors, the plurality of instructions comprising instructions which, when executed by the one or more processors, cause the one or more processors to perform actions including the method or performed by the system or pool cleaner of any preceding or subsequent statement or combination of statements.
GG. A method of controlling a pool cleaner by performing the actions of the system or pool cleaner of any preceding or subsequent statement or combination of statements.
HH. The pool cleaner, system, method, or storage medium of any preceding or subsequent statement or combination of statements, wherein the pool cleaner comprises a body with a top and sidewalls, and wherein the light source is on the top and/or on the sidewalls of the body.
II. The pool cleaner, system, method, or storage medium of any preceding or subsequent statement or combination of statements, wherein the light source includes two or more light sources.
JJ. The pool cleaner, system, method, or storage medium of any preceding or subsequent statement or combination of statements, wherein the light source is configured to emit collimated light.
KK. The pool cleaner, system, method, or storage medium of any preceding or subsequent statement or combination of statements, wherein the pool surface is submerged, and the image is used to measure a distance from the pool surface.
LL. The pool cleaner, system, method, or storage medium of any preceding or subsequent statement or combination of statements, wherein the body comprises a top end and a lower end, and wherein the light source is closer to the lower end of the body than to the top end.
MM. The pool cleaner, system, method, or storage medium of any preceding or subsequent statement or combination of statements, wherein the pool cleaner further comprises a body.
NN. The pool cleaner, system, method, or storage medium of any preceding or subsequent statement or combination of statements, further comprising a control system, wherein the control system is configured to control the light source based on at least one characteristic of the camera.
OO. The pool cleaner, system, method, or storage medium of any preceding or subsequent statement or combination of statements, wherein the at least one characteristic of the camera is a change in angle or orientation of the camera relative to the pool cleaner, and wherein the control system is configured to control at least one of illumination from the light source or an orientation of the light source based on the at least one characteristic of the camera.
PP. The pool cleaner, system, method, or storage medium of any preceding or subsequent statement or combination of statements, further comprising a control system, wherein the control system is configured to control illumination from the light source based on sensed information from at least one sensor.
QQ. The pool cleaner, system, method, or storage medium of any preceding or subsequent statement or combination of statements, wherein the at least one sensor is configured to detect ambient light.
RR. A self-propelled pool cleaner for a swimming pool or spa, the self-propelled pool cleaner comprising: a body; a camera supported on the body; a light source supported on the body and configured to illuminate a field of view of the camera.
SS. The pool cleaner, system, method, or storage medium of any preceding or subsequent statement or combination of statements, further comprising a control system, wherein the control system is configured to control illumination from the light source.
TT. A self-propelled pool cleaner for a swimming pool or spa, the self-propelled pool cleaner comprising: a body; and a light source supported on the body, wherein the light source is orientable relative to the body.
UU. The pool cleaner, system, method, or storage medium of any preceding or subsequent statement or combination of statements, further comprising a camera supported on the body, wherein the light source is orientable based on movement of the camera.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

As used herein, the meaning of “a,” “an,” and “the” includes singular and plural references unless the context clearly dictates otherwise.

The subject matter of embodiments of the present disclosure is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described. A zero angle refers to an angle of 0° or 180°. Directional references such as “up,” “down,” “top,” “bottom,” “left,” “right,” “vertical,” “horizontal,” “lateral,” “longitudinal,” “front,” and “back,” among others, are intended to refer to the orientation as illustrated and described in the figure (or figures) to which the components and directions are referencing.

The terms “comprising,” “having,” “including,” and “containing” are to be construed as open-ended terms (i.e., meaning “including, but not limited to,”) unless otherwise noted. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

The above-described aspects are merely possible examples of implementations, merely set forth for a clear understanding of the principles of the present disclosure. Many variations and modifications can be made to the above-described embodiment(s) without departing substantially from the spirit and principles of the present disclosure. All such modifications and variations are intended to be included herein within the scope of the present disclosure, and all possible claims to individual aspects or combinations of elements or steps are intended to be supported by the present disclosure. Moreover, although specific terms are employed herein, as well as in the claims that follow, they are used only in a generic and descriptive sense, and not for the purposes of limiting the described embodiments, nor the claims that follow.

That which is claimed:

1. A self-propelled pool cleaner for a swimming pool or spa, the self-propelled pool cleaner comprising:
a body;
a camera supported on the body; and
a light source supported on the body and configured to illuminate a field of view of the camera.

2. The self-propelled pool cleaner of claim 1, wherein the camera is movable relative to the body, and wherein the light source is orientable based on movement of the camera.

3. The self-propelled pool cleaner of claim 1, further comprising a control system, wherein the control system is configured to control illumination from the light source based on ambient light within the swimming pool or spa.

4. The self-propelled pool cleaner of claim 3, wherein the control system is configured to control the light source based on movement of the camera by controlling the light source to follow a change in orientation or movement of the camera and/or to cancel shadows and/or illuminate areas with lower light.

5. The self-propelled pool cleaner of claim 3, wherein the control system is configured to control illumination from the light source by controlling an on/off status of the light source.

6. The self-propelled pool cleaner of claim 3, wherein the control system is configured to control illumination from the light source by controlling a color of visible light emitted by the light source.

7. The self-propelled pool cleaner of claim 3, wherein the control system is configured to control illumination from the light source by controlling an intensity of light emitted by the light source.

8. A self-propelled pool cleaner for a swimming pool or spa, the self-propelled pool cleaner comprising:
a body; and
a light source supported on the body, wherein the light source is orientable relative to the body.

9. The self-propelled pool cleaner of claim 8, further comprising a camera supported on the body, wherein the light source is orientable based on movement of the camera.

10. The self-propelled pool cleaner of claim 8, further comprising a camera and a control system, wherein the control system is configured to control the orientation of the light source based on the camera.

11. The self-propelled pool cleaner of claim 8, wherein a control system is configured to control the light source based on movement of a camera by controlling the light source to illuminate areas with lower light.

12. The self-propelled pool cleaner of claim 8, wherein a control system is further configured to control illumination from the light source based on sensed information from at least one sensor.

13. The self-propelled pool cleaner of claim 12, wherein the at least one sensor is configured to detect ambient light.

14. The self-propelled pool cleaner of claim 8, wherein the body comprises a top end and a lower end, and wherein the light source is closer to the lower end of the body than to the top end.

15. A self-propelled pool cleaner for a swimming pool or spa, the self-propelled pool cleaner comprising:
a body comprising a top end and a lower end;
a camera supported on the body; and
a light source supported on the body, wherein the light source is closer to the lower end of the body than to the top end.

16. The self-propelled pool cleaner of claim 15, wherein the light source is at or proximate to the lower end.

17. The self-propelled pool cleaner of claim 15, further comprising a control system, wherein the control system is configured to control the light source based on at least one characteristic of the camera.

18. The self-propelled pool cleaner of claim 17, wherein the at least one characteristic of the camera is a change in angle or orientation of the camera relative to the pool cleaner, and wherein the control system is configured to control at least one of illumination from the light source or an orientation of the light source based on the at least one characteristic of the camera.

19. The self-propelled pool cleaner of claim 15, further comprising a control system, wherein the control system is configured to control illumination from the light source based on sensed information from at least one sensor.

20. The self-propelled pool cleaner of claim 19, wherein the at least one sensor is configured to detect ambient light.
